(19) United States
(12) Patent Application Publication
(10) Pub. No.: US 2020/0330804 A1
(43) Pub. Date: Oct. 22, 2020

(54) FIRE PROTECTION ELEMENT FOR SEALING THROUGH-OPENINGS IN CONSTRUCTION ELEMENTS

(71) Applicant: HILTI AKTIENGESELLSCHAFT, Schaan (LI)

(72) Inventors: Mario PAETOW, Igling (DE); Herbert MUENZENBERGER, Wiesbaden (DE); Rudolf SEMLER, Prittriching (DE); Horst ZIPFEL, Landsberg am Lech (DE)

(73) Assignee: Hilti Aktiengesellschaft, Schaan (LI)

(21) Appl. No.: 16/305,263

(22) PCT Filed: Jun. 12, 2017
(86) PCT No.: PCT/EP2017/064227

§ 371 Date: Nov. 28, 2018

(30) Foreign Application Priority Data
Jun. 24, 2016 (EP) 16176114.3

(51) Int. Cl. A62C 2/06; F16L 5/04; B32B 27/12

(52) U.S. Cl. CPC A62C 2/065; B32B 2307/3065; B32B 27/12; F16L 5/04

(57) ABSTRACT

A strip-shaped fire-protection element, in particular for a line fed through a through-opening of a construction element includes a flat inner layer, extending in a longitudinal direction and having an intumescent material; a reinforcement layer of a fiber composite material, which reinforcement material is applied to at least one first flat side of the inner layer and extends in the longitudinal direction of the fire protection element, wherein the reinforcement layer covers the inner layer at least partially in a width direction.

### TECHNICAL FIELD

The invention relates to the sealing of penetration openings in construction elements, such as building components, through which the lines are routed. Furthermore, the present invention relates to fire-protection elements containing intumescent material.

### TECHNICAL BACKGROUND

During the laying of lines, such as pipelines, electrical lines and the like, these are routed through penetration openings in construction elements, especially building components, such as wall and ceilings. In order to prevent the passage of fire and smoke gases in the fire situation, sealing materials are introduced between inner walls of the penetration openings and the lines being routed therethrough. The sealing materials are usually equipped with intumescent material or are formed from such, so that the material expands under the effect of heat, such as occurs in the fire situation, and thereby presses against the line and seals the penetration opening in the construction element.

One problem of the fire-protection elements introduced into the intermediate spaces between the pipelines and the penetration openings consists in the fact that the expansion of the intumescent materials takes place in such an unguided manner that a large part of the expanded material is forced laterally out of the penetration opening and thus only a small pressure is exerted on the line. In addition, the material forced out of the penetration opening is unprotected and thus exposed to mechanical stresses, such as a jet of extinguishing water or the like, and so the forced-out proportion of the expanded intumescent material is not resistant in the fire situation.

Furthermore, the speed of compression of the routed line is reduced by the lateral forcing of the material out of the penetration opening, and so a sealing time required in the fire situation may not be achieved under certain circumstances.

It is the object of the present invention to provide a fire-protection element with which an intermediate space between an inner face of a penetration opening and a line routed therethrough can be sealed, and whereby it is ensured that intumescent material of the fire-protection element is forced out of the intermediate space to a reduced extent as it expands and consequently the line routed therethrough is compressed to an increased extent.

### DISCLOSURE OF THE INVENTION

This object is solved by the fire-protection element according to claim 1 as well as by the arrangement, according to the secondary claim, of the fire-protection element in an intermediate space between a construction element and a line.

Further configurations are specified in the dependent claims.

According to a first aspect, a strip-like fire-protection element for a line routed through a construction element is provided, comprising:
a flat inner layer containing an intumescent material;
a reinforcing layer of a fiber composite material, which is applied on at least one first flat side of the inner layer and extends in the long direction of the fire-protection element, wherein the reinforcing layer covers the inner layer at least partly in a width direction.

One idea of the foregoing fire-protection element consists in equipping an inner layer of intumescent material with a reinforcing layer of a reinforcing material over part of its width, so that, by bending over in the region of the reinforcing layer, a folded-over edge of the fire-protection element is formed that externally surrounds the reinforcing layer.

During insertion of the fire-protection element into an intermediate space between a construction element and a line, the folded-over edge of the fire-protection element points outward from the intermediate space. When the intumescent material of the inner layer expands in the fire situation, the regions of the reinforcing layer surrounding the folded-over edge are pressed against a shell surface of the line and an inner shell surface of the penetration opening, and therefore the folded-over edge of the fire-protection element is fixed frictionally against movement in axial direction of the line routed therethrough. Thereby escape of the intumescent material from the intermediate space between the construction element and the line as the intumescent material expands further is prevented by the reinforcing layer, which is fixed by clamps, and so an increased pressure is exerted in the direction of the line.

Furthermore, the reinforcing layer may be enveloped on a second flat side by at least one of the lateral rims of the inner layer.

In particular, the reinforcing layer may partly cover the second flat side of the inner layer.

It may be provided that the fiber composite material of the reinforcing layer comprises an industrial fiber from the group consisting of glass fibers, ceramic fibers, carbon fibers, polyamide fibers, metal fibers, aramide fibers, boron fibers, natural fibers, stone fibers and mixtures thereof.

Furthermore, the fiber composite material of the reinforcing layer may be a glass-fiber material, especially a glass-fiber nonwoven, a glass-fiber scrim, a knitted glass fiber fabric or a woven glass-fiber fabric.

According to one embodiment, the reinforcing layer may have, on at least the first flat side of one side, material weakness regions, which in particular extend in width direction.

In particular, the material weakness regions may be formed by incisions, stamped lines or perforations. The material weakness regions may be provided in regions of the reinforcing layer that are not enveloped by the folded-over edges of the inner layer. In this way, it is ensured that, in the fire situation, during expansion of the intumescent material, the material weakness regions permit escape of the expanding intumescent material, and so this is not prevented from expansion in transverse direction relative to the axial direction of the penetration opening through the construction element.

Furthermore, the intumescent material may be an intumescent foam, an intumescent coating or an intumescent strip.

The reinforcing layer may be bonded to the inner layer by stapling, adhesive bonding, squeegeeing, riveting, rolling, welding, extruding or interlocking. In particular, the reinforcing layer may be squeegeed onto one flat side of the inner layer. Furthermore, the reinforcing layer may be designed as at least one layer.

According to one embodiment, the fiber composite material may have a temperature resistance up to at least 500° C. Beyond this, a metal strip may be provided in the inner layer.

The fire-protection element may be folded over along its long direction, in order to form a folded-over edge that is reinforced on the outer side by the reinforcing layer. Thus the folded-over edge is oriented in long direction of the fire-protection element and may therefore be cut to any desired lengths.

According to a further aspect, an arrangement of the foregoing fire-protection element is provided in a penetration opening of a construction element through which a line is routed, wherein the fire-protection element seals one axial end of the penetration opening in such a way that the folded-over edge points outward and regions of the reinforcing layer bear on the shell surface of the penetration opening and on the shell surface of the line.

### BRIEF DESCRIPTION OF THE DRAWINGS

Embodiments will be explained in more detail hereinafter on the basis of the attached drawings, wherein:

FIG. 1 shows a perspective diagram of a fire-protection element for insertion in an intermediate space between a construction element and a line;

FIG. 2 shows a cross-sectional diagram of the fire-protection element of FIG. 1 in an unfolded condition; and

FIG. 3 shows an arrangement of fire-protection elements in an intermediate space between a construction element and a line routed therethrough.

### DESCRIPTION OF EMBODIMENTS

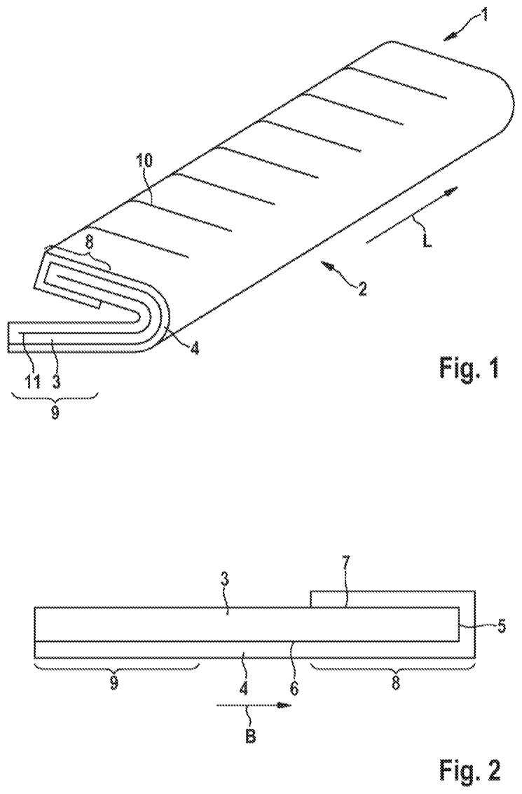

FIG. 1 illustrates a perspective diagram of a portion of a strip-like fire-protection element 1, which extends in a long direction L and may be supplied as roll material, which can be cut to the needed length.

Fire-protection element 1 is equipped with a folded-over edge 2, which may be permanently provided or may be formed shortly before mounting by folding over fire-protection element 1 appropriately along its long direction. Fire-protection element 1 has an expandable inner layer 3, which is formed entirely or partly from an intumescent material. The intumescent material has the property that it expands and fills free volume under the effect of heat, especially fire heat. Inner layer 3 may be formed with an intumescent foam, an intumescent coating or an intumescent material layer.

Furthermore, a metal strip 11, which extends in long direction L and partly or completely over the width B of inner layer 3, may be provided in inner layer 3, in order to achieve, in the fire situation, good heat conduction to regions of fire-protection element 1 not directly exposed to the heat effect of fire gases or flames. In this way, a volume change of the intumescent material can be achieved in the case of local heating effect even in regions of fire-protection element 1 far from the heat input.

Inner layer 3 is covered at least on one side by a reinforcing layer 4, which is formed from a reinforcing material. Reinforcing layer 4 is fastened on one flat side of inner layer 3, and in particular is attached by stapling, adhesive bonding, riveting, rolling, welding, extruding or interlocking. In particular, reinforcing layer 4 may be squeegeed onto the flat side of inner layer 3.

The reinforcing material of reinforcing layer 4 may be or contain a fiber composite material and may contain one or more of the following industrial fibers: glass fibers, ceramic fibers, carbon fibers, polyamide fibers, metal fibers, aramide fibers, boron fibers, natural fibers, stone fiber and the like. Furthermore, the fiber composite material may be a glass-fiber material, especially a glass-fiber nonwoven, a glass-fiber scrim, a knitted glass fiber fabric or a woven glass-fiber fabric.

Preferably, the fiber composite material has temperature resistance, such that it continues to exhibit a high tearing strength at a temperature at which the maximum volume change of the intumescent material is reached and does not exhibit any reduced tearing strength relative to normal temperature (e.g. 20° C.). As an example, the reinforcing material may have a temperature resistance of at least 500° C.

Inner layer 3 may be bent over in order to form folded-over edge 2, which extends along long direction L of fire-protection element 1. Thus folded-over edge 2 forms an edge of fire-protection element 1 that is covered on the outer side by reinforcing layer 4.

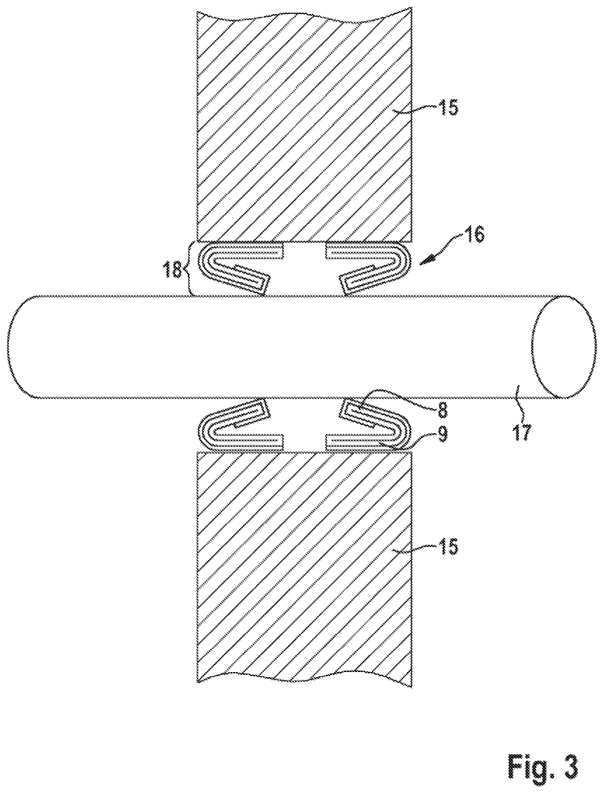

In the present exemplary embodiment, as shown in FIG. 2, reinforcing layer 4 covers inner layer 3 on a first side 6 completely over its entire width B and, beyond this, a lateral edge 5 of inner layer 3 adjoining this and a portion of a second side 7 of inner layer 3 that is disposed opposite first side 6 and adjoins lateral edge 5. Thereby a fire-protection element 1 is formed that, relative to its width, has a first sealing portion 8 and a second sealing portion 9 which, upon being folded over into a ready-to-use condition, as shown in FIG. 1, are able to form substantially two limbs of a U-shaped cross section.

In the shown embodiment, reinforcing layer 4 may be equipped on first side 6, at least in first sealing portion 8, with material weakness regions 10, which run in width direction B and may have the form of incisions, stamped lines or perforations. Material weakness regions 10 may be elongated or have different geometric shapes.

When the intumescent material expands in the fire situation, these material weakness regions 10 permit tearing apart and escape of the expanding intumescent material of inner layer 3, so that fire-protection element 1 in the ready-to-use condition spreads out transversely relative to long direction L and exerts pressure on a face on which there bears the outer side of the limb, formed by first sealing portion 8, of fire-protection element 1 bent into U-shape.

Because reinforcing layer 4 is applied on both sides in first sealing portion 8, this effect is further intensified by the fact that the reinforcing layer 4 releases the expanding intumescent material along the material weakness regions 10, so that it expands and exerts pressure in the direction of the face on which the limb in question bears.

FIG. 3 shows a cross-sectional diagram of an arrangement of fire-protection element 1 in an intermediate space 18 between a penetration opening 16 of a construction element 15 and a line 17 routed through the penetration opening, such as a pipeline or electrical line. Two fire-protection elements 1, which respectively are intended to seal one axial end of penetration opening 16 and for this purpose are disposed in penetration opening 16 in a manner surrounding line 17, are shown in cross section.

For sealing of an axial end of penetration opening 16, fire-protection element 1 is introduced with its folded-over edge 2 pointing outwardly around line 17 into the intermediate space, so that the limbs of the U-shaped cross section of fire-protection element 1 bear on a portion of the shell surface of line 17 and on a portion of the inner shell surface of penetration opening 16.

In the present exemplary embodiment, first sealing portion 8 is disposed on the inner side of the U-shaped cross section, so that material weakness regions 10 bear substantially on the shell surface of line 17 or are turned toward it. In case of the effect of fire heat, the volume of the intumescent material of inner layer 3 in first sealing portion 8 increases, wherein the increased volume of intumescent material has space only for expansion through material weakness regions 10 and thus presses against the shell surface of line 17 in the interior of penetration opening 16. Thereby it is ensured that, in the fire situation, the pressure on the shell surface of line 17 is increased already at the beginning of expansion of the intumescent material and line 17 is already compressed promptly after outbreak of a fire, in order to seal penetration opening 16 completely. This is particularly effective in conjunction with embedded metal strip 11, since thereby the fire heat is transported into the region of first sealing portion 8. At the same time, reinforcing layer 4 acts in the region of folded-over edge 2, which seals the axial end of penetration opening 16 toward the outside in such a way that no intumescent material escapes from penetration opening 16, whereby the pressure of the volume expansion of the intumescent material remains guided into the interior of penetration opening 16, so that the compression of line 17 is supported.

### LIST OF REFERENCE SYMBOLS

1 Fire-protection element
2 Folded-over edge
3 Inner layer
4 Reinforcing layer
5 Lateral edge
6 First side
7 Second side
8 First sealing portion
9 Second sealing portion
10 Material weakness regions
11 Metal strip
15 Construction element
16 Penetration opening
17 Line
18 Intermediate space

1: A strip-like fire-protection element, comprising:
a flat inner layer, extending in a long direction and comprising an intumescent material; and
a reinforcing layer of a fiber composite material, which is applied on at least a first flat side of said flat inner layer and extends in the long direction of the fire-protection element, wherein the reinforcing layer covers said flat inner layer at least partly in a width direction.

2: The fire-protection element according to claim 1, wherein the reinforcing layer is enveloped on a second flat side by at least one of the lateral rims of the inner layer.

3: The fire-protection element according to claim 2, wherein the reinforcing layer partly covers the second flat side of said flat inner layer.

4: The fire-protection element according to claim 1, wherein the fiber composite material of the reinforcing layer comprises at least one industrial fiber selected from the group consisting of glass fibers, ceramic fibers, carbon fibers, polyamide fibers, metal fibers, aramide fibers, boron fibers, natural fibers, stone fibers and mixtures thereof.

5: The fire-protection element according to claim 1, wherein the fiber composite material of the reinforcing layer is a glass-fiber material.

6: The fire-protection element according to claim 1, wherein the reinforcing layer has material weakness regions, on at least the first flat side of one side.

7: The fire-protection element according to claim 6, wherein the material weakness regions are formed by at least one material weakness selected from the group consisting of incisions, stamped lines and perforations.

8: The fire-protection element according to claim 1, wherein the intumescent material is at least one material selected from the group consisting of an intumescent foam, an intumescent coating and an intumescent strip.

9: The fire-protection element according to claim 1, wherein the reinforcing layer is bonded to said flat inner layer by at least one technique selected from the group consisting of stapling, adhesive bonding, squeegeeing, riveting, rolling, welding, extruding and interlocking.

10: The fire-protection element according to claim 9, wherein the reinforcing layer is squeegeed onto the at least one flat side of said flat inner layer.

11: The fire-protection element according to claim 1, wherein the reinforcing layer is at least one layer.

12: The fire-protection element according to claim 1, wherein the fiber composite material has a temperature resistance up to at least 500° C.

13: The fire-protection element according to claim 1, wherein a metal strip is provided in the inner layer.

14: The fire-protection element according to claim 1, wherein the fire-protection element is folded over along its long direction, in order to form a folded-over edge that is reinforced on an outer side by the reinforcing layer.

15: An arrangement of the fire-protection element according to claim 14 in a penetration opening of a construction element through which a line is routed, wherein the fire-protection element seals one axial end of the penetration opening in such a way that the folded-over edge points outward and regions of the reinforcing layer bear on a shell surface of the penetration opening and on a shell surface of the line.
